(19) United States
(12) Patent Application Publication
(10) Pub. No.: US 2016/0068941 A1
(43) Pub. Date: Mar. 10, 2016

(54) METHOD FOR PREPARING COATINGS OR POWDERS BY MIXED-MODE PLASMA SPRAYING

(71) Applicant: HiFunda LLC, Salt Lake City, UT (US)

(72) Inventors: Balakrishnan Nair, Sandy, UT (US); Jiwen Wang, Storrs-Mansfield, CT (US)

(73) Assignee: HiFunda LLC, Salt Lake City, UT (US)

(21) Appl. No.: 14/846,214

(22) Filed: Sep. 4, 2015

Related U.S. Application Data
(60) Provisional application No. 62/045,628, filed on Sep. 4, 2014.

(51) Int. Cl. C23C 4/10; C23C 4/12; C04B 35/44

(52) U.S. Cl. CPC C23C 4/105; C04B 35/44; C23C 4/127

(57) ABSTRACT

A process for producing a coating includes preparing at least one feedstock liquid precursor by dispersing at least one powder into a solution of at least one salt in at least one solvent, injecting the liquid precursor into a plasma jet to form a residue, and depositing the residue onto a surface. The powder includes at least one chemical compound including at least a first chemical element. The salt includes at least a second chemical element.

### CROSS-REFERENCE TO RELATED APPLICATIONS

This application claims the benefit of U.S. Provisional Application No. 62/045,628, filed on Sep. 4, 2014, which is incorporated by reference herein in its entirety.

### BACKGROUND

Ceramic coatings are used for a variety of applications including for environmental protection from, for example, high temperature, oxidation, wear, corrosion etc.

### SUMMARY

Embodiments of a process for producing a coating are described. In one embodiment, the process for producing a coating includes preparing at least one feedstock liquid precursor by dispersing at least one powder into a solution of at least one salt in at least one solvent, injecting the liquid precursor into a plasma jet to form a residue, and depositing the residue onto a surface. The powder includes at least one chemical compound including at least a first chemical element. The salt includes at least a second chemical element. Other embodiments of a process for producing a coating are described.

Embodiments of a process for producing a coating are described. In one embodiment, the process for producing a coating includes preparing at least one feedstock liquid precursor by dispersing at least a first powder and a second powder, injecting the liquid precursor into a plasma jet to form a residue, and depositing the residue onto a surface. The first powder includes at least one chemical compound comprising at least a first chemical element. The second powder a second chemical compound including at least a second chemical element. Other embodiments of a process for producing a coating are described.

Embodiments of a coating are described. In one embodiment, the coating includes a residue produced by a process including preparing at least one feedstock liquid precursor by dispersing at least one powder into a solution of at least one salt in at least one solvent, injecting the liquid precursor into a plasma jet to form a residue, and depositing the residue onto a surface. The powder includes at least one chemical compound including at least a first chemical element. The salt includes at least a second chemical element. Other embodiments of a coating are described.

### BRIEF DESCRIPTION OF THE DRAWINGS

FIG. 1 depicts a schematic diagram of an embodiment of a powder in a solution.

FIG. 2 depicts a schematic diagram of another embodiment of two powders in a solution.

FIG. 3 depicts a schematic diagram of an embodiment of a process for producing a coating.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments described herein relate to application of coatings by plasma spray. In particular, some embodiments relate to manufacturing of thermal barrier coating systems for metal surfaces that are subject to high temperature use, such as the surfaces of turbine blades and vanes.

A preparation method for manufacturing of coatings by plasma spraying relates to the manufacturing of thermal barrier coatings through a mixed solution/suspension spray process. In particular, an embodiment is a method of using mixed solution and suspension plasma spraying to prepare ultra-high temperature yttrium aluminum garnet (YAG, Y₃Al₅O₁₂) thermal barrier coatings. In particular an embodiment relates to manufacturing of a ceramic coating in such a way that at least some of the mass of the coating after it is sprayed and fully stabilized was originally sprayed into the plasma flame in the form of a suspension and at least some of the mass of the coating after it is sprayed on and fully stabilized is sprayed in a solution form.

There are a variety of applications for ceramic coatings including environmental protection from high temperature, oxidation, wear, corrosion etc. Plasma spray is a common and cost effective method for manufacturing of coatings. Well known methods of manufacturing ceramic components using plasma spray include injecting a powder, a suspension or a solution into the plasma jet. In many of these applications, the desired composition may not be easily attainable by spraying any one of these types of input materials into the plasma flame alone. For example, the desired architecture may be a multi-phase material, with two or more phases, and with very different grain size requirements for the two phases. In other instances, one or more of the constituents may not have a precursor material that is sufficiently soluble in water or an appropriate solvent, and spraying of powder alone may result in a microstructure that is unacceptable. In other instances, the desired microstructure may be complex with one phase required to form a shell around another phase. In these instances, it may be desirable to start with some of the constituents in a solution, and some of the constituents in a powder or suspension.

The thermodynamic efficiency of gas turbines can be improved significantly by maximizing inlet temperature and/or reducing the volume of air required for cooling airfoils. A promising approach to achieve higher operating temperatures is the use of thermal barrier coatings (TBCs). Yttria-stabilized zirconia with 6-8 weight percent yttria (7YSZ) has been widely and successfully used for over 40 years due to its combination of outstanding materials properties. However, 7YSZ TBCs are limited to a maximum operating surface temperature of 1200-1300° C. due to the potential for damaging phase changes. Considerable global research and development have been directed at developing advanced TBCs with higher surface temperature capability. These development efforts have only met with limited success, in part, because most oxide ceramics have greater thermal expansion mismatch strains and, therefore, poorer durability than those produced by 7YSZ. Conventional air plasma spray (APS) TBCs, used in industrial gas turbine (IGT) engines, do not have sufficient strain tolerance to overcome the higher thermal expansion mismatch. One approach is to use a YAG material with proven thermal stability and excellent high-temperature mechanical properties. YAG and other higher temperature TBCs have not been used to date because of inadequate durability, resulting from (a) poor erosion resistance and (b) greater thermal expansion mismatch strains compared to 7YSZ.

In some embodiments, a mixed solution/powder or solution/suspension plasma spray (SPS) process may produce YAG TBCs with excellent durability because of its strain-tolerant microstructure. The substitution of the conventional spray powders by mixed suspension/solutions offers new possibilities, such as the direct use of finely dispersed powders that are readily available and not requiring the use of precursor salts of yttrium and aluminum that generally have poor solubility in water and other conventional solvents and thus saving in the production of specific thermal spraying feedstock powder, and the production of nanostructured coatings.

In one embodiment, the feedstock liquid precursors are prepared by dispersing at least one powder, the powder including at least one chemical compound, the chemical compound including at least a first chemical element, into a solution of at least one salt in at least one solvent, the salt comprising at least a second chemical element. Upon injection into a plasma jet and deposition of the resulting residue onto a surface, the resulting coating or film will comprise of the at least one first chemical element and the at least one second chemical element. If sprayed into a liquid bath it may be possible to produce a powder or agglomerate comprising the at least one first chemical element and the at least one second chemical element. In some embodiments, the resulting material, be it in the form of a coating/film or powder will be a ceramic material. In some embodiments, the resulting material, be it in the form of a coating/film or powder will be an oxide ceramic material, including a complex oxide material or a composite. In some embodiments, the coating/film will possess a microstructure that is appropriate for the particular application. In some embodiments for application as thermal barrier coatings, the coating/film may contain a vertically cracked architecture that allows the coating to have sufficient compliance to result in the ability to survive thermal cycling. In other embodiments, where the requirement is for a gas tight coating or film such as for environmental protection, dense membranes for gas separation through ion transport etc, the coating may be nominally dense or possess only closed porosity. It should be noted that for all the embodiments noted here, the injection of the first and second element precursors (i.e powders or solutions) may be done either simultaneously through the same injector, or through separate injectors. In some embodiments, especially for the formation of composites or shelled structures, it may be desirable to inject the precursors at different points in the plasma flame. For example, it may be desirable to inject a powder into a cooler part of the plasma flame if the final product is intended to contain the same composition, particle size, and/or morphology etc. as the injected particles.

One example of the use of an embodiment described herein is in the manufacturing of YAG TBCs. YAG is phase stable up to its melting point (1970° C.), while YSZ exhibits a tetragonal to monoclinic transformation when cooled from temperatures above 1200-1300° C. Thus, YAG has a maximum use temperature that is potentially 700° C. higher than YSZ based on this criterion as a monolithic ceramic. In some embodiments, YAG may have a practical use temperature that as high as 1400° C. for TBCs.

YAG has a very low density of 4.55 g/cc, a 25% reduction compared to YSZ. The density advantage means that, at a standard TBC thickness, YAG would exert less pull (stress) on the blade root or, for the same blade pull, thicker YAG TBCs could be used for greater thermal insulation.

YAG has a much higher hardness than YSZ: 1700 vs 1200 Vickers. The higher hardness, combined with greater fracture toughness for unique microstructures, can be used to improve TBC erosion resistance. Alternatively, the higher hardness can be traded off for higher porosity content and reduced thermal conductivity.

YAG has equal to or slightly higher thermal conductivity to YSZ at 1000° C. YSZ has almost a constant value of thermal conductivity with temperature; whereas, YAG's thermal conductivity continually decreases with temperature. Extrapolation of the YAG thermal conductivity data from the 1000° C. to 1350° C. (the maximum use temperature for YSZ), indicates that YAG should have lower thermal conductivity compared with YSZ.

In some embodiments, YAG is a superior high temperature low thermal conductivity TBC, with a lower thermal expansion coefficient and superior durability compared to YSZ because of its strain tolerant microstructure. The vertical cracking can give SPS TBCs a strain tolerance similar to what can be achieved in the more expensive and slower electron beam physical vapor deposition (EB-PVD) process while also including additional microstructural features like high porosity and inter-pass boundaries that give a much lower thermal conductivity than what is achievable through the EB-PVD process.

Embodiments of SPS YAG TBCs can provide an enabling technology for next generation, high-temperature high-efficiency turbine systems. Potential public benefits include lower energy consumption and fuel cost savings, electricity cost savings, emissions reduction, system reliability, job creation, conservation of land and water resources, and U.S. gas-turbine power-generation equipment exports.

From an environmental standpoint, it is estimated that a reduction of up to 165 million tons of CO₂ per year could be achieved in the United States alone by displacing older, less efficient, intermediate coal, oil, and natural-gas fired steam plants with next-generation turbines.

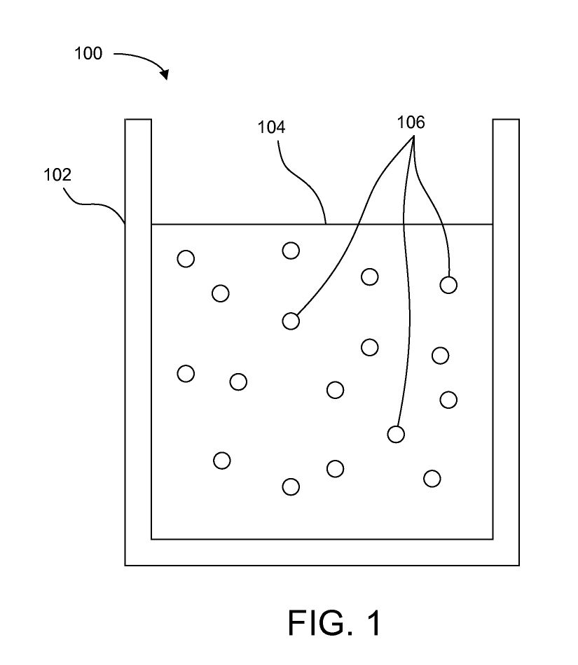

To manufacture YAG TBCs through this method, the feedstock liquid precursors may be prepared by dispersing one oxide powder (Y₂O₃ or Al₂O₃) into a solution containing the other element i.e. Al in solution if the powder is Y₂O₃, or Y in solution if the powder is Al₂O₃). Typically, the decision on injecting one of the materials being done in powder form is based on factors such as the cost of precursors, solubility of available precursor salts etc. The solution Al or Y source may be prepared by dissolving Al or Y salts, such as aluminum nitrate or yttrium nitrate in a liquid media, such as H₂O (FIG. 1). FIG. 1 depicts a schematic diagram of an embodiment of a powder in a solution. In the illustrated embodiment 100, a solution 104 is located within a container 102. In some embodiments, the solution 104 is an Al solution. In some embodiments, the solution 104 is a Y solution. In some embodiments, the solution 104 may be prepared by dissolving salts, such as aluminum nitrate or yttrium nitrate, in a liquid media. In the illustrated embodiment, a powder 106 is dispersed into the solution 104. In some embodiments, the powder 106 is an oxide powder. In some embodiments, the powder is Y₂O₃. In some embodiments, the powder is Al₂O₃. Some embodiments include a powder 106 and a solution 104. While the illustrated embodiment utilizes a powder and a solution, other embodiments involve other forms and compositions in various combinations, such as just solutions, just powders, mixtures, suspensions, the combinations of which is selected based on desired properties and availability.

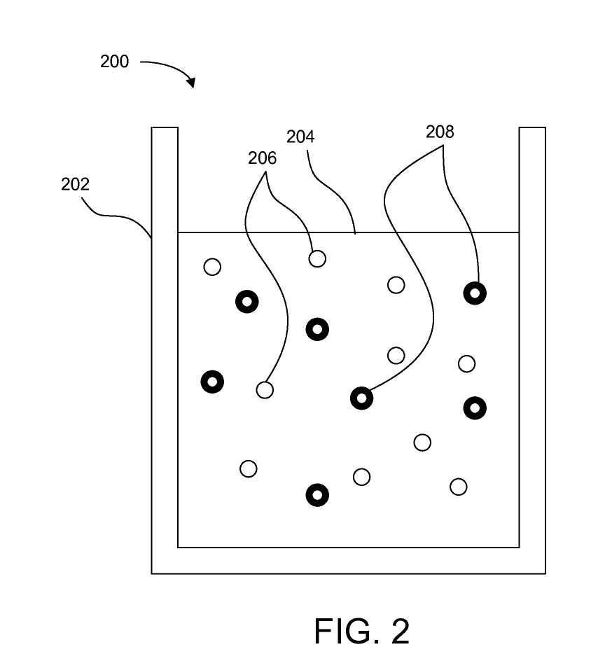

The suspension precursor can also be prepared by dispersing oxide powders of Y₂O₃ or Al₂O₃, in a liquid media, such as H₂O. (FIG. 2). FIG. 2 depicts a schematic diagram of another embodiment of two powders in a solution. The illustrated embodiment 200 includes a first powder 206 and a second powder 208 dispersed into a solution 204 within a container 202. In some embodiments, the first powder 206 is Y₂O₃. In some embodiments, the first powder 206 is Al₂O₃. In some embodiments, the second powder 206 is Y₂O₃. In some embodiments, the second powder 206 is Al₂O₃. In some embodiment, the solution 204 is a liquid media. In some embodiments, the solution is H₂O. In other embodiments, the solution is another liquid media. In some embodiments, the first powder 206 is injected or dispersed from a first injector and the second powder 208 is injected or dispersed from a second injector. In some embodiments, the first 206 or second powder 208 may be injected as a suspension.

It should be noted that one of the ingredients may be injected as a solution through a first injector and the other may be injected as a suspension or powder through another injector.

The suspension may have a solid content of 5%-50% and may satisfy the stoichiometric requirement for forming YAG thermal barrier coatings. The concentration of solution of Al or Y source is between 1M and 10M. A dispersant, such as but not limited to, polyethylene glycol (PEG), acetic acid etc., with a concentration of 0.01 wt % to 10 wt % may be used to achieve stable suspensions.

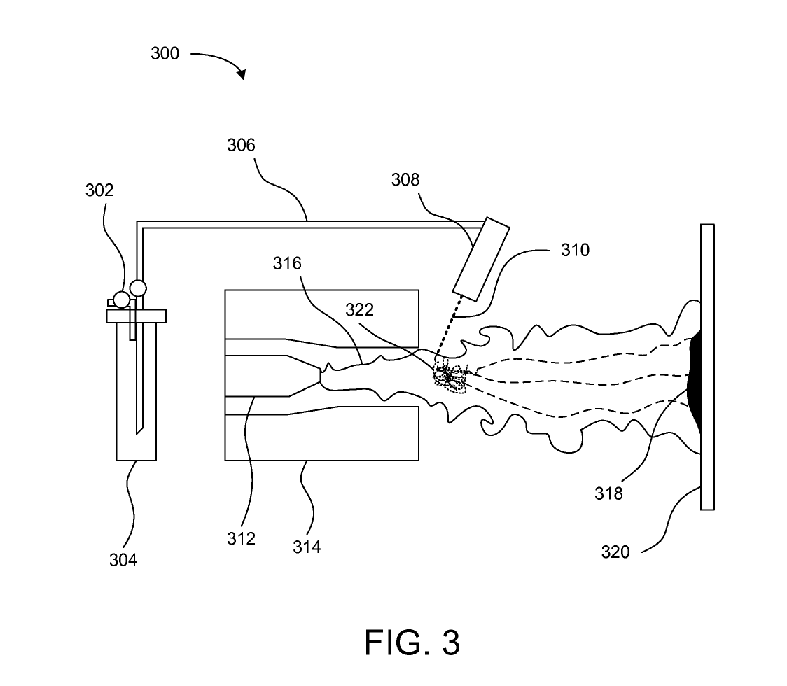

The suspension of fine particles (micron- or nano-sized), with agglomerates, may be injected into plasma jets. Suspension is a good way to inject fine particles with the suitable momentum in plasma jet, otherwise, these fine particles would require very high carrier gas flow rates (as high as 50 slm (standard liter per minute)), which may hugely perturb the plasma jet. The result may be droplets containing solid particles. After evaporation, the solid particles are melted, combined or mixed with the materials formed from the solution precursor, and projected onto a prepared substrate to form a coating/film or a liquid bath to form a powder (FIG. 3).

FIG. 3 depicts a schematic diagram of an embodiment of a process 300 for producing a coating 318 on a surface 320. In the illustrated embodiment, a plasma jet 316 is produced from a cathode 312 and an anode 314. In other embodiments, other process may be used to form a plasma jet 316. In the illustrated embodiment, a suspension 310 of fine particles is injected into the plasma jet 316. In some embodiments, the suspension 310 are micron-sized fine particles. In some embodiments, the suspension 310 are nano-sized fine particles. In some embodiments, the suspension 310 includes agglomerates. In the illustrated embodiment, a solution and powder mixture or other suspensions may be within a container 304 that injects the suspension through a passage 306 and an injector 308 by use of compressed air 302. The suspension 310 is injected by the injector 308 into the plasma jet 316, which may result in droplets containing sold particles 322. From this a residue is formed on a surface 320 that results in a suitable coating 318.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of method(s) and processes herein are shown and described in a particular order, the order of the operations of each may be altered so that certain operations may be performed in an inverse order or so that certain operations may be performed, at least in part, concurrently with other operations.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A process for producing a coating comprising:
preparing at least one feedstock liquid precursor by dispersing at least one powder into a solution of at least one salt in at least one solvent, the powder comprising at least one chemical compound comprising at least a first chemical element, the salt comprising at least a second chemical element;
injecting the liquid precursor into a plasma jet to form a residue; and
depositing the residue onto a surface.

2. The process of claim 1, the residue forming the coating, wherein the coating comprises the first chemical element and the second chemical element.

3. The process of claim 2, wherein the coating comprises yttrium aluminum garnet (YAG).

4. The process of claim 2, wherein the coating is used as a thermal barrier coating.

5. The process of claim 1, wherein the first chemical element is Yttrium.

6. The process of claim 1, wherein the first chemical element is Aluminum.

7. A process for producing a coating comprising:
preparing at least one feedstock liquid precursor by dispersing at least a first powder and a second powder, the first powder comprising at least one chemical compound comprising at least a first chemical element, the second powder comprising a second chemical compound comprising at least a second chemical element;
injecting the liquid precursor into a plasma jet to form a residue; and
depositing the residue onto a surface.

8. The process of claim 7, the residue forming the coating, wherein the coating comprises the first chemical element and the second chemical element.

9. The process of claim 8, wherein the coating comprises yttrium aluminum garnet (YAG).

10. The process of claim 8, wherein the coating is used as a thermal barrier coating.

11. The process of claim 7, wherein the first chemical element is Yttrium.

12. The process of claim 7, wherein the first chemical element is Aluminum.

13. The process of claim 7, wherein the first powder is dispersed by a first injector and the second powder is dispersed by a second injector.

14. The process of claim 7, wherein the first powder and the second powder are dispersed by a single injector.

15. A coating comprising:
a residue produced by a process comprising:
preparing at least one feedstock liquid precursor by dispersing at least one powder into a solution of at least one salt in at least one solvent, the powder comprising at least one chemical compound comprising at least a first chemical element, the salt comprising at least a second chemical element;
injecting the liquid precursor into a plasma jet to form the residue; and
depositing the residue onto a surface.

16. The coating of claim 15, the residue forming the coating, wherein the coating comprises the first chemical element and the second chemical element.

17. The coating of claim 16, wherein the coating comprises yttrium aluminum garnet (YAG).

18. The coating of claim 16, wherein the coating is used as a thermal barrier coating.

19. The coating of claim 15, wherein the first chemical element is Yttrium.

20. The coating of claim 15, wherein the first chemical element is Aluminum.
